(19) United States
(12) Patent Application Publication
(10) Pub. No.: US 2011/0030007 A1
(43) Pub. Date: Feb. 3, 2011

(54) BROADCAST RECEIVING APPARATUS AND DISPLAYING METHOD THEREOF

(75) Inventor: Bong-hwan CHO, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 12/751,673

(22) Filed: Mar. 31, 2010

(30) Foreign Application Priority Data
Jul. 29, 2009 (KR) 10-2009-0069479

(51) Int. Cl. H04N 5/445

(52) U.S. Cl. 725/40

(57) ABSTRACT

Disclosed is a displaying method of a broadcast receiving apparatus using Internet, the method including: receiving and storing user's interesting information through the Internet; inspecting booting screen setting for displaying the user's interesting information if receiving a power-on command from a user; and displaying the stored user's interesting information according to inspecting results during a booting time needed for displaying a normal screen.

### CROSS-REFERENCE TO RELATED APPLICATION

This application claims priority from Korean Patent Application No. 10-2009-0069479, filed on Jul. 29, 2009 in the Korean Intellectual Property Office, the disclosure of which is incorporated herein by reference.

### BACKGROUND

1. Field

Apparatuses and methods consistent with the exemplary embodiments relate to a broadcast receiving apparatus and a displaying method thereof, and, more particularly, to a broadcast receiving apparatus and a displaying method thereof, which can display interesting information of a user during booting based on a power-on command.

2. Description of the Related Art

As a broadcast receiving apparatus such as a television (TV) plays a central role in a user's home, the TV may need to process various functions. Thus, the TV needs to have diverse function blocks for processing such various functions.

As more functions are added to the TV, the booting time for initializing diverse function blocks and loading an operating system (OS) therefor in response to a power-on command is increased. For example, the total booting time needs almost 10 seconds if it takes (1) 2.5 seconds to initialize a central processing unit (CPU) and a memory and load the OS, (2) 3 seconds to initialize a frame rate conversion (FRC), an integrated circuit (IC) for improving image quality, and a sound IC, (3) 2.5 seconds to play a melody to indicate execution of the booting process, (4) 0.5 seconds to inspect a resolution, and (5) 0.8 seconds to set up image quality based on the set resolution, etc.

In particular, a high grade TV with integrated circuits (ICs) for various functions and quality improvement needs a long booting time, and thus a user has to tediously and inconveniently wait until a normal screen is displayed. Accordingly, there is needed a method for meaningfully utilizing the booting time.

### SUMMARY

One or more exemplary embodiments provide a broadcast receiving apparatus and a displaying method thereof, which can display interesting information of a user during a booting time in a power-on process, thereby saving a user from tedium and inconvenience.

One or more exemplary embodiments also provide a broadcast receiving apparatus and a displaying method thereof, which utilizes a booting time of a power-on process for providing a user with interesting information.

One or more exemplary embodiments also provide a broadcast receiving apparatus and a displaying method thereof, which utilizes a booting time of a power-on process for providing a user with updatable interesting information related to his/her interesting theme.

According to an aspect of an exemplary embodiment, there is provided a displaying method of a broadcast receiving apparatus using the Internet, the method including: receiving and storing a user's interesting information through the Internet; inspecting booting screen setting for displaying the user's interesting information if receiving a power-on command from a user; and displaying the stored user's interesting information according to inspecting results during a booting time needed for displaying a normal screen.

The receiving and storing the user's interesting information may include determining whether it reaches a time to update the user's interesting information; and receiving and storing the user's interesting information from an Internet service provider if it reaches the update time.

The user's interesting information may be updated corresponding to at least one of a time set by a user, a time calculated by a user's viewing pattern, and a time when a request for update is received from the Internet service provider.

The user's interesting information may include information related to a user's interesting theme including at least one of weather, stocks, news, an electronic program guide (EPG), travel, sports, and real estate.

The booting screen setting may include at least one of whether to display the user's interesting information during the booting time, display specifications of the user's interesting information, the user's interesting theme to which the user's interesting information belongs, and an updating method of the user's interesting information.

The user's interesting information may be updated while the broadcast receiving is in a standby power mode.

The user's interesting information may be displayed with image quality lower than the normal screen.

The user's interesting information may include text information.

The displaying the user's interesting information includes selecting Vsync, Hsync and data enable signals adapted to display specifications of the broadcast receiving apparatus according to the inspecting results; and displaying the stored user's interesting information on the basis of the selected Vsync, Hsync and data enable signals.

The displaying method may further include providing an Internet service provider with at least one of an update time and a user's interesting theme to which the user's interesting information belongs.

According to an aspect of another exemplary embodiment, there is provided a broadcast receiving apparatus using the Internet, including: a storage unit which stores a user's interesting information and a booting screen setting for displaying the user's interesting information; a communication unit which is connected to the Internet; an inspecting unit which inspects the booting screen setting related to the user's interesting information if receiving a power-on command from a user; and a control unit which stores the user's interesting information received through the communication unit in the storage unit, and displays the stored user's interesting information according to inspecting results of the inspecting unit during a booting time needed for displaying a normal screen.

The control unit may determine whether it reaches a time to update the user's interesting information; and receives the user's interesting information from an Internet service provider and stores the user's interesting information in the storage unit if it reaches the update time.

The control unit may control the user's interesting information to be updated corresponding to at least one of a time set by a user, a time calculated by a user's viewing pattern, and a time when a request for update is received from the Internet service provider.

The user's interesting information may include information related to a user's interesting theme including at least one of weather, stocks, news, an electronic program guide (EPG), travel, sports, and real estate.

The booting screen setting may include at least one of whether to display the user's interesting information during the booting time, display specifications of the user's interesting information, the user's interesting theme to which the user's interesting information belongs, and an updating method of the user's interesting information.

The control unit may update the user's interesting information while the broadcast receiving apparatus is in a standby power mode.

The control unit may display the user's interesting information with an image quality that is lower than the image quality of a normal screen.

The user's interesting information may include text information.

The control unit may select Vsync, Hsync and data enable signals adapted to display specifications of the broadcast receiving apparatus according to the inspecting results; and display the stored user's interesting information on the basis of the selected Vsync, Hsync and data enable signals.

The control unit may provide an Internet service provider with at least one of an update time and a user's interesting theme to which the user's interesting information belongs.

### BRIEF DESCRIPTION OF THE DRAWINGS

The above and/or other aspects will become apparent and more readily appreciated from the following description of the exemplary embodiments, taken in conjunction with the accompanying drawings, in which:

FIG. 1 is a block diagram of a broadcast receiving apparatus according to an exemplary embodiment;

FIG. 2 is a block diagram of schematically showing a control unit to explain a method for updating a user's interesting information;

FIG. 3 schematically shows booting screen settings according to an exemplary embodiment; and

FIG. 4 is a flowchart for explaining a displaying method of a broadcast receiving apparatus according to an exemplary embodiment.

### DETAILED DESCRIPTION OF EXEMPLARY EMBODIMENTS

Below, exemplary embodiments will be described in detail with reference to accompanying drawings so as to be easily realized by a person having ordinary knowledge in the art. The exemplary embodiments may be embodied in various forms without being limited to the exemplary embodiments set forth herein. Descriptions of well-known parts are omitted for clarity, and like reference numerals refer to like elements throughout.

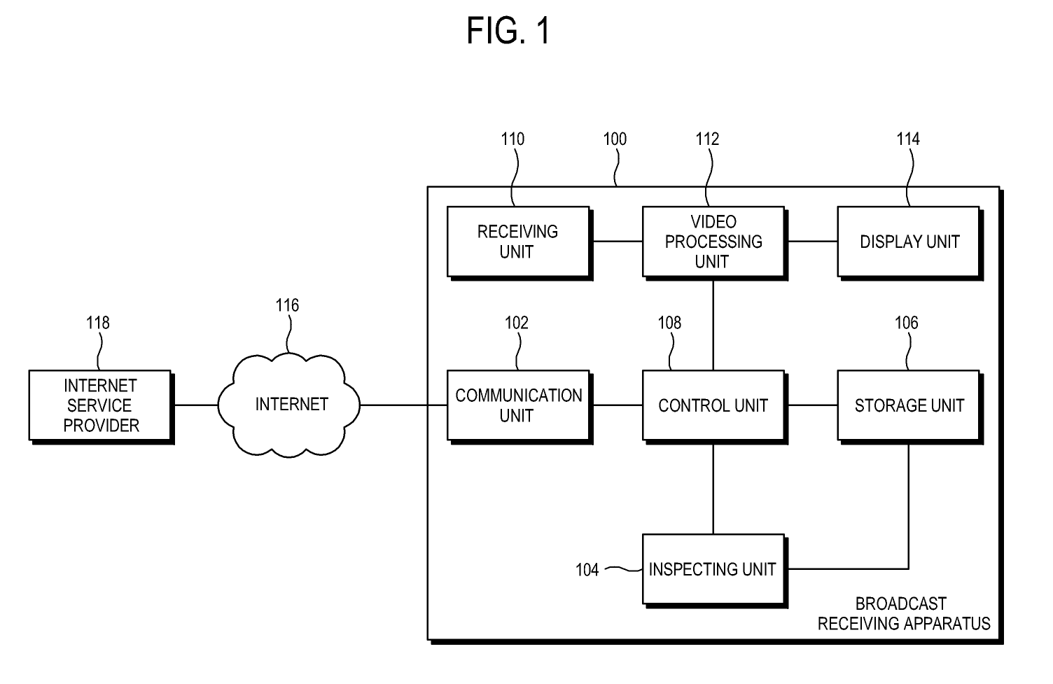

FIG. 1 is a block diagram of a broadcast receiving apparatus according to an exemplary embodiment. As shown therein, a broadcast receiving apparatus 100 includes a communication unit 102, an inspecting unit 104, a storage unit 106, a control unit 108, a receiving unit 110, a video processing unit 112 and a display unit 114.

The broadcast receiving apparatus 100 is connected to an Internet service provider 118 through the Internet 116, and receives a user's interesting information related to a user's interesting theme from the Internet service provider 118. Further, the broadcast receiving apparatus 100 displays the user's interesting information during a booting time when the broadcast receiving apparatus is powered on. Also, the broadcast receiving apparatus 100 updates the user's interesting information by communicating with the Internet service provider 118.

Here, the broadcast receiving apparatus 100 may be a digital TV using the Internet.

The booting time may be provided for displaying a normal screen when the broadcast receiving apparatus 100 receives a power-on command. For example, the booting time may be required for (1) initializing a CPU and memory and loading an OS, (2) initializing an FRC, an IC for image quality improvement and a sound IC, (3) playing a melody indicating execution of the booting process, (4) inspecting a resolution, and (5) setting up image quality based on a set resolution.

The user's interesting information may be provided by the Internet service provider 118 via the Internet 116, and include information related to the user's interesting theme including at least one of weather, stocks, news, an electronic program guide (EPG), travel, sports, and real estate.

The communication unit 102 performs Internet protocol (IP) communication with the Internet service provider 118 and receives and transmits various data. In this exemplary embodiment, the communication unit 102 transmits a user's interesting theme and an updating method to the Internet service provider 118, and receives the user's interesting information corresponding the user's interesting theme from the Internet service provider 118. The Internet service provider 118 transmits the user's interesting information to the communication unit 102 based on the updating method.

The inspecting unit 104 inspects the booting screen settings related to the user's interesting information when receiving the power-on command from a user. In this exemplary embodiment, the booting screen settings may include at least one of whether to display the user's interesting information during the booting time, display specifications of the user's interesting information, the user's interesting theme to which the user's interesting information belongs, and an updating method of the user's interesting information.

The storage unit 106 may include various storage media such as a flash memory, an electrically erasable and programmable read only memory (EEPROM), a hard disc, etc., in which the user's interesting information and the booting screen settings may be stored.

The control unit 108 may control the storage unit 106 to store the user's interesting information received through the communication unit 102, and control the stored user's interesting information to be displayed during the booting time required for displaying a normal screen in response to inspecting results of the inspecting unit 106.

The control unit 108 may control the display unit 114 to display a menu screen for setting up a booting screen. When the booting screen is completely set up by a user, the control unit 108 may store the setting results in the storage unit 106.

The control unit 108 determines whether it reaches a time to update the user's interesting information. If it is time to update the user's interesting information, the control unit 108 receives the user's interesting information from the Internet service provider 118 through the communication unit 102, and stores the received user's interesting information in the storage unit 106. In this exemplary embodiment, the control unit 108 may control the user's interesting information to be updated corresponding to at least one of a time set by a user, a time calculated by a user's viewing pattern, and a time when a request for update is received from the Internet service provider 118.

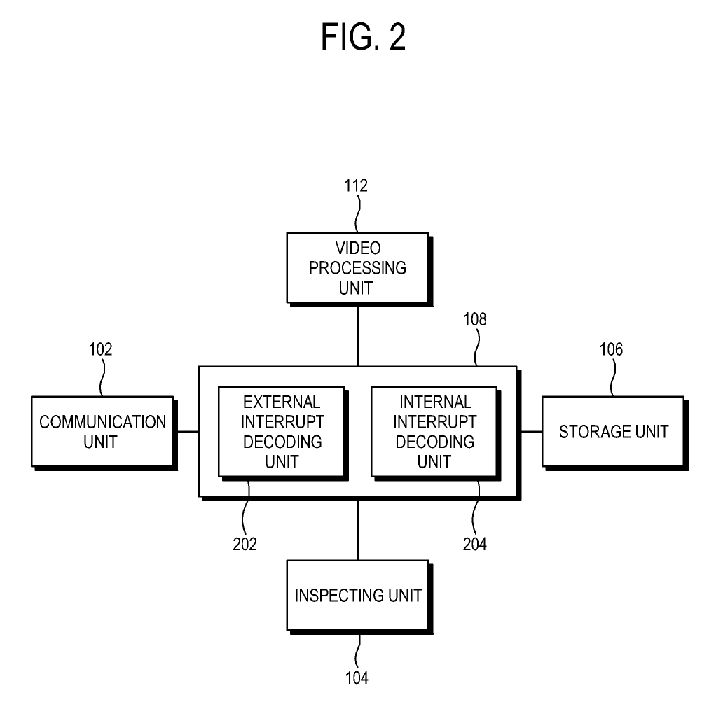

For example, the control unit 108 may determine whether it reaches a time to update the user's interesting information when an interrupt occurs, and update the user's interesting information. Below, occurrence of an interrupt for the update will be described with reference to FIG. 2.

FIG. 2 is a block diagram of schematically showing the control unit 108 to explain a method for updating a user's interesting information.

Referring to FIG. 2, the control unit 108 in this exemplary embodiment includes an external interrupt decoding unit 202 and an internal interrupt decoding unit 204.

When receiving an update request from the Internet service provider 118, the external interrupt decoding unit 202 determines that the interrupt for the update occurs. At this time, the control unit 108 stores and updates the user's interesting information received from the Internet service provider 118 in the storage unit 106.

At an update time set by a user with reference to the booting screen settings, the internal interrupt decoding unit 204 determines that the interrupt for the update occurs. At this time, the control unit 108 stores and updates the user's interesting information received from the Internet service provider 118 in the storage unit 106.

The internal interrupt decoding unit 204 analyzes a viewing pattern of a user, and determines an update time depending on the analyzed results. At the update time, the internal interrupt decoding unit 204, determines that the interrupt for the update occurs. At this time, the control unit 108 stores and updates the user's interesting information received from the Internet service provider 118 in the storage unit 106. Here, the user's viewing pattern may include a viewing time when the user views a broadcast, and the internal interrupt decoding unit 204 may determine an update time to be earlier than the general viewing time by a predetermined amount of time.

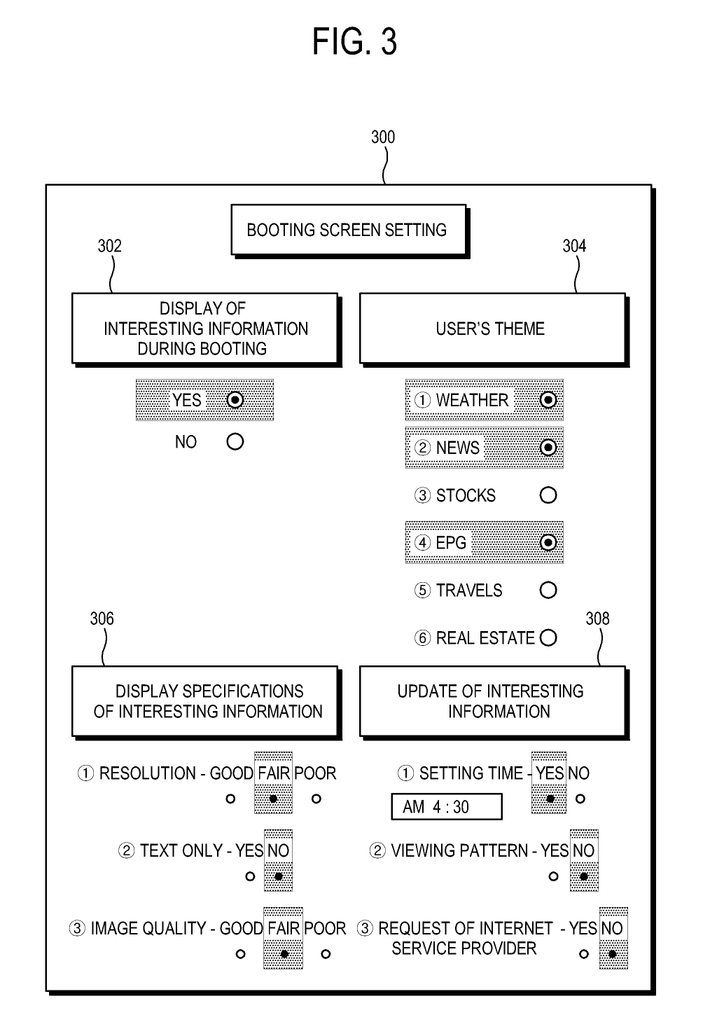

Referring back to FIG. 1, after the broadcast receiving apparatus 100 receives the power-on command from a user, the control unit 108 control the user's interesting information to be displayed corresponding to the inspecting results of the inspecting unit 104 during the booting time for displaying a normal screen. Here, the inspecting results depend on the booting screen settings. Below, the settings of the booting screen will be described with reference to FIG. 3.

FIG. 3 schematically shows booting screen settings according to an exemplary embodiment, in which the booting screen may be set up directly by a user or automatically by the user's viewing pattern analyzed by the control unit 108.

In the booting screen setting 300, setting items include “display of interesting information during booting” 302, “user's theme” 304, “display specifications of interesting information” 306 and “update of interesting information” 308.

The “display of interesting information during booting” 302 is a setting item about whether to display the user's interesting information during the booting time before displaying a normal screen when the broadcast receiving apparatus 100 receives the power-on command and starts the booting process.

The “user's theme” 304 is a setting item about themes such as weather, stocks, news, an EPG, travel, sports, real estate, etc. In this exemplary embodiment, if weather, news and an EPG are selected, the user's interesting information about weather, news and an EPG may be displayed during the booting time. For example, if the user's interesting theme is news; the user's interesting information may include today's home and abroad news. If the user's interesting theme is weather, the user's interesting information may include today's weather.

The “display specifications of interesting information” 306 is a setting item about a graphic resolution and image quality of the user's interesting information, whether to show the user's interesting information using only text, etc. In this exemplary embodiment, if it is set up that the “\textcircled{1} resolution” is “fair”, the “\textcircled{2} image quality” is “fair” and the “\textcircled{3} text only” is “no”, the user's interesting information may be displayed at a preset fair resolution and image quality and by a moving picture or graphics as well as text.

In this exemplary embodiment, if it is set up that the “\textcircled{1} resolution” is “poor” or the “\textcircled{3} text only” is “yes”, the amount of information for displaying the user's interesting information is decreased and the signal process is simplified, thereby allowing a user to view more of the user's interesting information faster.

The “update of interesting information” 308 is a setting item about a method of updating the user's interesting information through the Internet. According to an exemplary embodiment, if it is set up that a “\textcircled{1} user's setting time” is “yes” and the setting time is set to “AM 4:30”, the control unit 108 controls the broadcast receiving apparatus 100 to update the user's interesting information through the Internet service provider 118 at AM 4:30.

According to an exemplary embodiment, if a “\textcircled{2} user's viewing pattern” is “yes”, the control unit 108 analyzes the user's viewing pattern and determines a time to update the user's interesting information according to the analyzed viewing patterns. For example, the control unit 108 may determine what time of day a user first views a broadcast for a certain period of time, store the determination in a database and analyze the database. In this case, the control unit 108 determines a first viewing time and starts updating the user's interesting information one hour before the determined first viewing time.

According to an exemplary embodiment, if “\textcircled{3} request of Internet service provider” is set to “yes”, the control unit 108 controls the user's interesting information to be updated automatically when receiving a request from the Internet service provider 118.

Referring to FIGS. 1 and 3, the control unit 108 displays the stored user's interesting information during the booting time needed for displaying a normal screen, based on the booting screen setting 300. Here, the normal screen is displayed to a user, and corresponds to a channel previously viewed by a user or a channel newly tuned by a user.

According to an exemplary embodiment, if the broadcast receiving apparatus 100 takes (1) 2.5 seconds to initialize a CPU and a memory and load the OS, (2) 3 seconds to initialize a frame rate conversion (FRC), an integrated circuit (IC) for improving image quality, and a sound IC, (3) 2.5 seconds to play a melody indicating execution of the booting process, (4) 0.5 seconds to inspect a resolution, and (5) 0.8 seconds to set up image quality based on a set resolution, etc., the broadcast receiving apparatus 100 may have a total booting time of almost 10 seconds until the normal screen is displayed after receiving the power-on command.

The control unit 108 quickly displays the user's interesting information after receiving the power-on command if it is set up to display the user's interesting information.

For example, the control unit 108 performs a high-speed display process. Here, the high-speed display process includes (1) a process of simple setting control, (2) a process of reading out the stored user's interesting information and (3) a process of outputting the user's interesting information through a display sync and a resolution determined in the process of the simple setting control. Here, the control unit 108 performs the high-speed display process in parallel with a general booting process, thereby displaying the user's interesting information. Thus, the control unit 108 may display the user's interesting information within one second of the broadcast receiving apparatus 100 being powered on.

In the high-speed display process, the control unit 108 omits processes of adjusting image quality/white balance, etc. so as to quickly show the user's interesting information. That is, the image quality of the displayed user's interesting information may be lower than the image quality of the normal screen.

That is, in the high-speed display process, the minimum process for graphic generation is performed to display the user's interesting information quickly. Alternatively, the high-speed display process may be performed prior to the general booting process, or may be performed as an interrupt routine of the general booting process.

In this exemplary embodiment, the control unit 108 controls the video processing unit 112 to send Vsync/Hsync/Enable signals and controls the user's interesting information to be displayed on the display unit 114, thereby displaying the user's interesting information.

In the process for the simple setting control, the Vsync/Hsync/Enable signals are generated properly for the resolution and the specifications of the broadcast receiving apparatus 100. In this case, the Vsync/Hsync/Enable signals are generated with reference to the “display specifications of interesting information” 306.

The control unit 108 provides the user's interesting theme to which the user's interesting information belongs and the update time to the Internet service provider 118 through the communication unit 102 on the basis of the booting screen setting 300. For example, the controller 108 transmits the setting time of “AM 4:30” set in the “update of interesting information” 308 and weather, news and an EPG set in the “user's theme 304” to the Internet service provider 118. In this case, the Internet service provider 118 sends the user's interesting information related to weather, news and an EPG to the broadcast receiving apparatus 100 at AM 4:30.

According to an exemplary embodiment, the control unit 108 may control the user's interesting information to be updated while the broadcast receiving apparatus 100 is in a standby power mode.

The receiving unit 110 is a block that receives a broadcast image, which has various standards. For example, if the broadcast receiving apparatus 100 is a TV, the receiving unit 110 may wirelessly receive a radio frequency (RF) signal from a broadcasting station (not shown), or may receive a video signal based on composite video, component video, super video, Scart, high definition multimedia interface (HDMI), or the like standards. Also, if the broadcast receiving apparatus 100 is a computer, the receiving unit 110 may receive a video signal based on D-Sub capable of transmitting RGB signals of VGA standards, digital video interactive (DVI), HDMI, or the like standards.

The video processing unit 112 processes the video signals transmitted from the receiving unit 110. For example, the processes performed in the video processor 112 may include decoding and encoding corresponding to various video formats, de-interlacing, frame refresh rate conversion, scaling, noise reduction for improving image quality, detail enhancement, etc.

The video processing unit 112 may be provided as individual modules to independently perform such respective processes, or as a single body into which various functions are integrated.

The video processing unit 112 may display an image by a local dimming method. In this case, the video processor 112 may control brightness according to a plurality of light source groups.

The display unit 114 includes a display panel which displays a broadcasting image based on the video signal processed by the video processing unit 112. In this exemplary embodiment, the display unit 114 may be provided in the form of a liquid crystal display (LCD), an organic light emitting diode (OLED), a plasma display panel (PDP), a field emission display (FED), or a cathode ray tube (CRT).

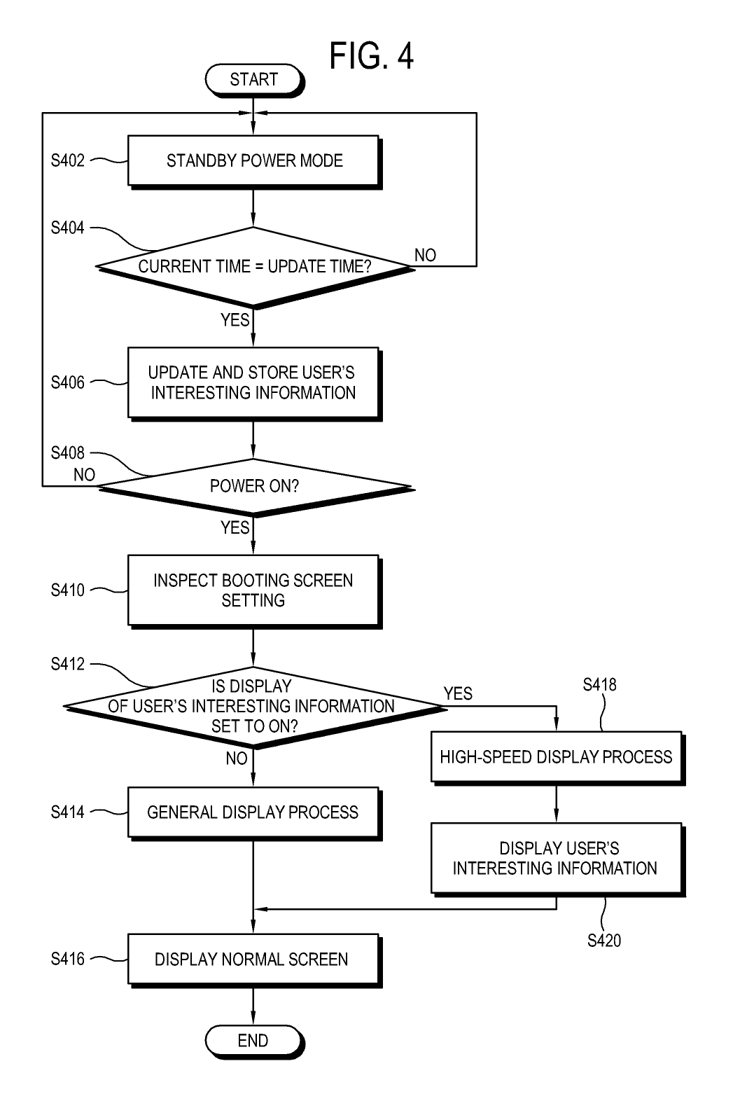

FIG. 4 is a flowchart for explaining a displaying method of a broadcast receiving apparatus according to an exemplary embodiment.

At operation 5402, the broadcast receiving apparatus is in a standby power mode.

Then, at operation S404, the broadcast receiving apparatus determines whether a current time corresponds to a time to update the user's interesting information. Here, the broadcast receiving apparatus may determine whether the update time is reached according to the previously stored booting screen settings.

According to an exemplary embodiment, the user's interesting information may be updated corresponding to at least one of a time set by a user, a time calculated by a user's viewing pattern, and a time when a request for update is received from the Internet service provider.

In this exemplary embodiment, the user's interesting information may be information related to the user's interesting theme including at least one of weather, stocks, news, an EPG, travel, sports, and real estate.

In this exemplary embodiment, the booting screen setting may include at least one of whether to display the user's interesting information during the booting time, display specifications about the user's interesting information, the user's interesting theme to which the user's interesting information belongs, and a method of updating the user's interesting information.

In this exemplary embodiment, the image quality of the user's interesting information may be lower than the image quality of the normal screen.

If it is determined that the current time is the update time, the broadcast receiving apparatus receives, updates and stores the user's interesting information from the Internet service provider at operation 5406.

At operation S408, the broadcast receiving apparatus determines whether the power-on command is given by a user. If the power-on command has not been received, the broadcast receiving apparatus returns to the standby power mode S402. If the power-on command has been received, the broadcast receiving apparatus inspects the booting screen setting related to the user's interesting information at operation S410.

According to the inspecting results, at operation S412, the broadcast receiving apparatus determines whether “display setting about user's interesting information” of the booting screen setting is on. If the “display setting about user's interesting information” is off, the broadcast receiving apparatus performs a general display process at operation S414. Here, the general display process is a procedure that includes (1) initializing the CPU/memory and loading the OS, (2) initializing the FRC, the IC for improving the image quality, and the sound IC, (3) playing the melody to indicate execution of the booting process, (4) inspecting the resolution, and (5) setting up the image quality based on the set resolution, etc. Then, at operation S416, a normal screen is displayed corresponding to a channel previously viewed by a user or a channel newly tuned by a user.

On the other hand, if the “display setting about user's interesting information” is on, at operation S418, the broadcast receiving apparatus performs the high-speed display process for displaying the user's interesting information after minimum graphics setting.

In the high-speed display process (S418), the process (not shown) of simple setting control and the process (not shown) of reading out the stored user's interesting information are performed. Then, at operation S420, the broadcast receiving apparatus displays the user's interesting information through a display sync and a resolution determined in the process of the simple setting control. Here, the process of simple setting control is to select the Vsync, Hsync, and data enable signals adapted to display specifications of the broadcast receiving apparatus corresponding to the results from inspecting the booting screen. After the general booting process is ended, the normal screen is displayed at operation S416.

In the high-speed display process in this exemplary embodiment, the general booting process is performed in parallel with the foregoing quick display of the user's interesting information. Alternatively, the high-speed display process (S418) may be performed prior to the general booting process, or may be performed as the interrupt routine of the general booting process. Here, the general booting process corresponds to a procedure performed in the general display process (S414).

Although it is not shown in FIG. 4, there may be added a process (not shown) of providing the Internet service provider with at least one of the update time and the user's theme to which the user's interesting information belongs.

Although a few exemplary embodiments have been shown and described, it will be appreciated by those skilled in the art that changes may be made in these exemplary embodiments, without departing from the principles and spirit of the invention, the scope of which is defined in the appended claims and their equivalents.

What is claimed is:

1. A method of displaying information using a broadcast receiving apparatus, the method comprising:
receiving and storing user information;
inspecting a booting screen setting if the broadcast receiving apparatus receives a power-on command; and
displaying the stored user information during a booting time of the broadcast receiving apparatus before displaying a normal screen, according to a result of the inspecting the booting screen setting.

2. The method according to claim 1, wherein the receiving and storing the user information comprises
determining whether a current time equals an update time; and
receiving and storing the user information if it is determined that the current time equals the update time.

3. The method according to claim 1, further comprising updating the user information at a time equal to at least one of a time set by a user, a time calculated according to a user viewing pattern, and a time when a request for update is received.

4. The method according to claim 1, wherein the user information comprises information related to a user theme including at least one of weather, stocks, news, an electronic program guide, travel, sports, and real estate.

5. The method according to claim 1, wherein the booting screen setting comprises at least one of a setting to display the user information during the booting time, a setting to display user information specifications, a setting to display a user theme to which the user information belongs, and a setting for a method of updating the user information.

6. The method according to claim 1, further comprising updating the user information while the broadcast receiving apparatus is in a standby power mode.

7. The method according to claim 1, wherein the user information is displayed with an image quality that is lower than an image quality of the normal screen.

8. The method according to claim 1, wherein the user information comprises text information.

9. The displaying method according to claim 1, wherein the displaying the user information comprises
selecting at least one of Vsync, Hsync and data enable signals adapted to display specifications of the broadcast receiving apparatus according to the inspecting results; and
displaying the stored user information based on the at least one selected Vsync, Hsync and data enable signals.

10. The displaying method according to claim 1, further comprising providing an Internet service provider with at least one of an update time and a user theme to which the user information belongs.

11. The displaying method according to claim 1, wherein the user information is received through the internet.

12. The method according to claim 1, further comprising analyzing a user viewing pattern and determining a user viewing start time based on the analyzing the user viewing pattern,
wherein the receiving and storing user information comprises receiving and storing user information before the user viewing start time.

13. The method according to claim 12, wherein the user information is received and stored a predetermined amount of time before the user viewing start time.

14. A broadcast receiving apparatus, comprising:
a display unit;
a communication unit which receives user information;
a storage unit which stores the user information and a booting screen setting for displaying the user information;
an inspecting unit which inspects the booting screen setting if the broadcast receiving apparatus receives a power-on command; and
a control unit which controls the storage unit to store the user information, and causes the stored user information to be displayed on the display unit during a booting time of the broadcast receiving apparatus before displaying a normal screen, according to a result of the inspection by the inspecting unit.

15. The broadcast receiving apparatus according to claim 14, wherein the control unit determines whether a current time equals an update time, the communication unit receives the user information, and the storage unit stores the user information if it is determined that the current time equals the update time.

16. The broadcast receiving apparatus according to claim 14, wherein the control unit controls the user information to be updated at a time equal to at least one of a time set by a user, a time calculated according to a user viewing pattern, and a time when a request for update is received.

17. The broadcast receiving apparatus according to claim 14, wherein the user information comprises information related to a user theme including at least one of weather, stocks, news, an electronic program guide, travel, sports, and real estate.

18. The broadcast receiving apparatus according to claim 14, wherein the booting screen setting comprises at least one of a setting to display the user information during the booting time, a setting to display user information specifications, a setting to display a user theme to which the user information belongs, and a setting for a method of updating the user information.

19. The broadcast receiving apparatus according to claim 14, wherein the control unit updates the user information while the broadcast receiving apparatus is in a standby power mode.

20. The broadcast receiving apparatus according to claim 14, wherein the control unit causes the user information to be displayed with an image quality that is lower than the image quality of the normal screen.

21. The broadcast receiving apparatus according to claim 14, wherein the user information comprises text information.

22. The broadcast receiving apparatus according to claim 14, wherein the control unit selects at least one of Vsync, Hsync and data enable signals adapted to display specifications of the broadcast receiving apparatus according to the inspecting results; and displays the stored user information based on the at least one selected Vsync, Hsync and data enable signals.

23. The broadcast receiving apparatus according to claim 14, the control unit provides an Internet service provider with at least one of an update time and a user theme to which the user information belongs.

24. The broadcast receiving apparatus according to claim 14, wherein the communication unit receives the user information through the internet.

25. The broadcast receiving apparatus according to claim 14, wherein the control unit analyzes a user viewing pattern and determines a user viewing start time based on the analyzed user viewing pattern,
wherein the storage unit stores the user information before the user viewing start time.

26. The broadcast receiving apparatus according to claim 25, wherein the storage unit stores the user information a predetermined amount of time before the user viewing start time.
